(19) United States
(12) Patent Application Publication
(10) Pub. No.: US 2022/0172261 A1
(43) Pub. Date: Jun. 2, 2022

(54) SYSTEM AND METHOD FOR EXCHANGES WITHIN PREDEFINED AREAS

(71) Applicant: Scott Foster, Ardmore, OK (US)

(72) Inventor: Scott Foster, Ardmore, OK (US)

(21) Appl. No.: 17/540,194

(22) Filed: Dec. 1, 2021

Related U.S. Application Data
(60) Provisional application No. 63/120,200, filed on Dec. 1, 2020.

(51) Int. Cl. G06Q 30/06

(52) U.S. Cl. CPC G06Q 30/0601

(57) ABSTRACT

A system and method is disclosed for a receiving user to trade things of value digitally for other things of greater value delivered in person comprising creating a profile on a software application for a seeking user, the profile including a transfer protocol for transferring an asset owned by the seeking user user to another user; requesting a good, service or thing of value from a group of fulfilling users of a software application deployed upon a personal device; selecting a fulfilling user from the group of delivering users; authenticating the identify of a seeking user and a fulfilling user using at least one security protocol; receiving a delivery of the good, service or other thing of value from the fulfilling user; and transferring an asset having a value greater than the amount of cash to the fulfilling user user using the transfer protocol.

### RELATED APPLICATIONS

This application claims priority from U.S. Provisional Application No. 63/120,200 filed on Dec. 1, 2020, and entitled “System and Method for P2P Cash Transfers,” the entire contents of which are hereby fully incorporated herein.

### BACKGROUND OF THE INVENTION

The invention relates to an improved method and system for transferring services and things of value between in a p2p, b2p, employee (e)2p, stranger to stranger (s2s) or other suborned agents thereof. The invention further relates to utilizing persons in a defined area who have products, items, money, electronic funds/currencies, credits or services available. The invention even further relates to a method for facilitating a transaction between two or more persons or mobile machines. The invention even further relates to a method for rewarding persons with products, items, money, electronic funds/currencies, credits or services available willing to transfer for other products, items, money, electronic funds/currencies, credits or services available in a secured manner.

### 1. FIELD OF THE INVENTION

The present invention relates to the fields of providing financial services. The present invention further relates to designing software applications to facilitate financial transactions between two or more parties. The present invention even further relates to a system of proving needed products, items, money, electronic funds/currencies, credits or services available from one party to another party in a convenient manner with defined and secure terms. The present invention further relates to exchanging things of value in a definable area.

### 2. DESCRIPTION OF RELATED ART

The idea of offering products, items, money, electronic funds/currencies, credits or services available to persons needing products, items, money, electronic funds/currencies, credits or services available is understood to be limited to ATMs or other brick and mortar shops.

There exists a need for a service that enables users with available products, items, money, electronic funds/currencies, credits or services to exchange with other users who need it. There exists a need for users to access products, items, money, electronic funds/currencies, credits or services with others in limited ranges or distances. There exists a need to skip lines at a store for various reasons. There exists a need at schools or other education and/or sports facilities, businesses, eateries, bars, casinos, college campuses, pro sporting events (hot dog/beer/salesmen to get food), cannabis retailers or other retailers to offer products, items, money, electronic funds/currencies, credits or services to nearby customers who do not wish to enter into a brick/mortar storefront. There exists another need for friends and anonymous users occupying a predefined area to exchange products, items, money, electronic funds/currencies, credits or services available with one another.

### SUMMARY OF THE INVENTION

These and other objects were met with the present invention. In an embodiment of the invention, a method for a receiving user to digitally trade things of value for products, items, money, electronic currencies, credits or services delivered in person is disclosed, the method comprising the steps of creating a profile on a software application for a seeking user, the profile including a transfer protocol for transferring an asset owned by the seeking user to another user; requesting a good, service or thing of value from a group of fulfilling users of a software application deployed upon a personal device; selecting a fulfilling user from the group of delivering users; authenticating the identify of a seeking user and a fulfilling user using at least one security protocol; receiving by a seeking user of the good, service or other thing of value from the fulfilling user; and transferring an asset to the fulfilling user using the transfer protocol, the method further comprising enabling at least one personal device of the seeking user and the fulfilling user to communicate with the system; the method further comprising establishing a geofence about a selected location and enabling the seeking user to select the scope of the geofence for the group of fulfilling users to receive notifications of an offer to an asset for a good, service or other thing of value, and enabling the seeking user to select the scope of the geofence for the group of fulfilling users to receive notifications of an offer to an asset for a good, service or other thing of value; the method further comprising activating the notifications for the seeking user and group of fulfilling users when occupying a location within the geofence; the method further comprising providing in the software application a push to talk engagement for the seeking user and fulfilling user to communicate without disclosing identifying data of the personal device.

In another embodiment of the invention, the method for a receiving user to digitally trade things of value for products, items, money, electronic currencies, credits or services delivered in person may be further utilized with a method for automated task list solutions, the method comprising inputting a task list relevant to the seeking user into to the system and processing the task list to sort the task list into identifiable goods or services that may be fulfilled by the step of requesting a good, service, or thing of value from a group of fulfilling users of a software application deployed upon a personal device; the method further comprising the step of using the profile of the seeking user to create parameters for attributes selected from the group of: defined area, range of values of identifiable goods or services, preferences for fulfilling users; the method further comprising the step of using historical information of past usage by the seeking user to create parameters for attributes selected from the group of: defined area, range of values of identifiable goods or services, preferences for fulfilling users; the method further comprising the step of authenticating the identity of a seeking user and of fulfilling user using at least one security protocol; the method further comprising the step of authenticating the value of the good, service or thing of value; the method further comprising the step of validating the asset from the step of transferring an asset to the fulfilling user using the transfer protocol; the method of whereby selected location is the seeking user, so that the geofence dynamically changes about the location of the seeking user; whereby the step of establishing a geofence about a selected location may further comprising increasing the range of the geofence after a period of time elapses without a fulfilling user agreeing to fulfill the request; method of, whereby the asset is cash currency and the step of validating the asset comprises a measure on the personal device of the seeking user for authenticating the cash currency; whereby the thing of value is cash currency and the step of validating the cash currency comprises a measure on the personal device of the seeking user for authenticating the cash currency; the method further comprising the step of establishing a market rate of the thing of value for evaluation by the seeking user or the group of fulfilling users; the method further comprising the step of establishing a market rate of the asset for evaluation by the seeking user or the group of fulfilling users; whereby the market rate of the asset and the thing of value are compared and a exchange rate is established for evaluation by the seeking user or the group of fulfilling users; the method further comprising the step of establishing an emergency security engagement within the software application on the personal device of the seeking user or the fulfilling user to contact emergency services; whereby a server stores the software application service, the data created by the user of the software application, and data created by the interactions by all seeking and fulling users of the software application; the method further comprising providing in the software application a push to talk engagement for the seeking user and fulfilling user to communicate without disclosing identifying data of the personal device.

### BRIEF DESCRIPTION OF THE DRAWINGS

A more complete understanding of the present invention may be derived by referring to the detailed description and claims when considered in connection with the FIGURES, where like reference numbers refer to similar elements throughout the FIGURES:

FIG. 1 depicts a flowchart for facilitating a cash transaction between two parties according to embodiments of the invention.

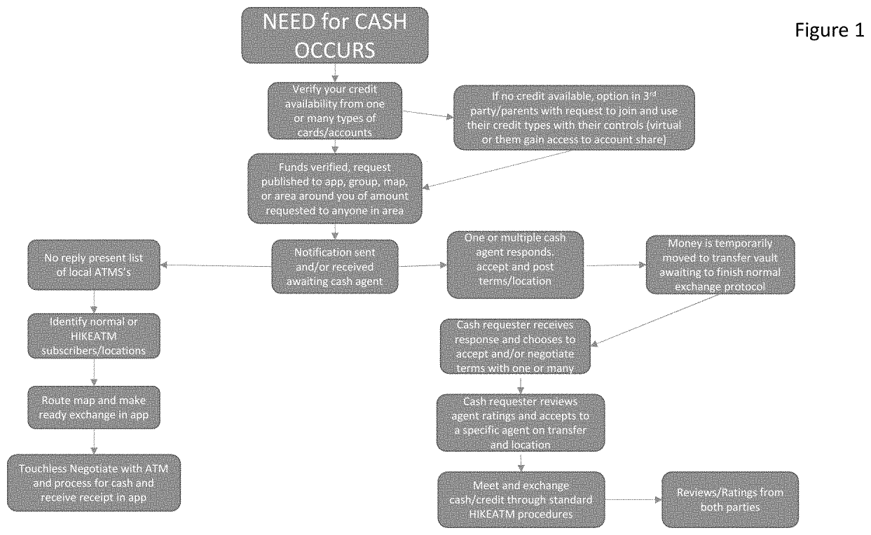

### DETAILED DESCRIPTION OF THE INVENTION

The present invention solves a number of issues with providing access to products, items, money, electronic funds/currencies, credits or services available for a person or party. The present invention provides a solution to a person seeking access to cash at a restaurant, ballgame, concerts, movie, casino, or other venues where exchanging products, items, money, electronic funds/currencies, credits or services available may be helpful. The present invention eliminates the need to have interactions with people, lines, and environments and surfaces are likely dirty and serve as vectors for communicable diseases. The present invention further solves the issue of a party seeking to convert cash to electronic credit or other things of value when banking deposits are not possible. The present invention provides solutions for security for users looking to exchange things of value.

According to the illustrations provided, a method and system of providing products, items, money, electronic funds/currencies, credits or services available to a person or party within a defined area defined by one or more of the users, or predefined based upon a location of the user.

In an embodiment of the inventive process, a first user has a need for cash money or the need to sell or disperse cash in exchange for value. These needs may be deployed through a software application to those who possess cash money in return for things of greater value. The first user may provide financial credentials that prove it is credit worthy and possesses financial accounts, products or other means to convey value digitally from an account that the first user associates with its profile in and on the inventive software application. The first user may provide a defined set of terms for an agreement, such as (but not limited to) a geographic area of desired recipients, amount of cash needed, level of proven successful transactions in the past or profile status. The notification may be communicated by a wireless signal to other devices. A second user or group of second users may receive the notification. The second user or group may be within a predefined group of users selected by the first user. By way of example and not limitation, the second user or group may be predefined as friends, co-workers, limited by gender, ability to provide a minimum level of cash, or other characteristic desirable by the first user. The second user or group may be limited by a geofence or boundary/perimeter about the first user, which may be dynamic according to embodiments of the invention to allow persons or machines to enter into a defined zone and become a potential second user or part of the second group, thereby receiving the notification from the first user. The location of the user may be set to a residence, work place or other safe public place as determined by one or more of the users. In other embodiments, the locations of the users may be set to a generalized or private mode so that a larger fence may be established further from an actual location of the user to maintain the privacy preferences by the one or more users.

In another embodiment of the inventive process, a first user has need to sell or disperse cash in exchange for value. These needs may be deployed through a software application to those who are in need of cash money or have the means to take possession or ownership in return for things of value from a second user. The first user may provide a defined set of terms for an agreement, such as (but not limited to) a geographic area of desired recipients, amount of cash to be exchanged to the second user, level of proven successful transactions in the past or profile status, and the cost for exchanging cash for electronic credit or other things of value, including exchange rate applications. The notification may be communicated by a wireless signal to other devices. A second user or group of second users may receive the notification on personal device. The second user or group may be within a predefined group of users selected by the first user. By way of example and not limitation, the second user or group may be predefined as friends, co-workers, limited by gender, ability to provide a minimum level of cash, or other characteristic desirable by the first user. The second user or group may be limited by a geofence or boundary/perimeter about the first user, which may be dynamic according to embodiments of the invention to allow persons or machines to enter into a defined zone and become a potential second user or part of the second group, thereby receiving the notification from the first user. The location of the user may be set to a residence, work place or other safe public place as determined by one or more of the users. In other embodiments, the locations of the users may be set to a generalized or private mode so that a larger fence may be established further from an actual location of the user to maintain the privacy preferences by the one or more users.

The notification may be deployed as a text or other form of instant or other message to a device(s) of the second user or group. The notification may further be deployed as a map based interface, showing the location of the first and/or individual second user(s). The notification may include a range of the terms preset by the first user, from none to all of the terms. Terms may include but are not limited to the following: location and range thereof, type thing of value sought, value limits, delivery requirements, time from request to delivery, security requirements, and other terms as discussed infra. The first user may select which terms are transparent to the second user or group of users, according to embodiments of the invention. The second user or group of users may be users of an inventive system such as a software application, such that they have associated existing financial products with an account that affords the second user with the ability to receive credit, electronic cash transfers or other things of value from the first user.

In other embodiment of the invention, the second user may notify those seeking cash or other things of value of its availability. The second user may share its location, maximum availability of cash on hand or ability to deliver other things of value, such as products, items, money, electronic funds/currencies, credits or services. Other profile statistics or characteristics may be shown as part of the second user icon, including by way of example and not limitation past historical transactions, reputation, and assisted speed of delivering the cash such as biking, vehicle, scooter, skates, and other means and capabilities of speeding up the transaction time. In this embodiment, the first user may select the second user based upon preferred characteristics outside of the strict agreement terms.

If the terms of the agreement are amenable, the second user or group of second users on an individual basis may take a step of affirmation by way or clicking or interacting with the software application to agree to provide products, items, money, electronic funds/currencies, credits or services in return for products, items, money, electronic funds/currencies, credits or services. The products, items, money, electronic funds/currencies, credits or services may exceed the value of the products, items, money, electronic funds/currencies, credits or services, according to embodiments of the invention. For example, the first user may offer $45 of credit for $40 of products, items, money, electronic funds/currencies, credits or services. Delivery fees may be factored into the offer, or may be an external fee outside of the listed products, items, money, electronic funds/currencies, credits or services. The inventive system may accept or add in other digital payment services such as apple pay, venmo, cash app or other sub vendors that may plug into the inventive system or application or otherwise fulfill the transfer of the items of value exceeding the value of cash. Other things of value may include gaming credentials, game tickets, free meals, gift cards, coupons, labor or other things of value without limitation.

The first user may then accept the affirmation of the initial second user, or alternatively select another from the group of second users who accept according to preferences that are preset or on an ad hoc basis. After the first user accepts the affirmation of the second user, the second user may then proceed to fulfilment of the financial transaction. The first and second users may meet in person so that the second user may deliver the thing of value to the first person. The inventive system may include security measures to ensure that the transfer of thing of value takes place according to the terms of the offer. For example, when the first user's credit is transferred to the account of the second user, the system may create a holding file of the credit issuer (first user) past the point of the system receiving a confirmation of the preliminary authorization of credit and cash money transfer, so that credit issuer has pledged additional security to the inventive system exceeding the value of the overall transaction. Further, one or more of the users may use their device and/or software application to record the images, audio and/or video to append to the transaction, adding a layer of fiduciary security as well as providing a measure of personal safety for the users of the system. Even further, authentication measures such as scanning a QR code, IR inks, bar code scan, Bluetooth, near field communications, tap to pay, Wi-Fi or Wi-Fi triangulation, cell/lte services, GPS coordinates, satellite or map images, or other device-to-device notification or IOT system, or other authentication may be utilized to provide a confirmation of the cash transaction being completed and the receiving party gaining possession of the cash being transferred by the second person. Similarly, cash, currency or other things of value may be authenticated using the devices controlled by the user(s), including cellular phones, computing devices, tablets, glasses, contacts, watches, wearables and other tools of technology. Thus, the camera function, near field, RFID, Bluetooth and other capabilities on a device may be used to authenticate safety measures available in cash/currency, such as security strips, chips, sensors, high resolution images, a picture of or input thereof of the serial number, location, and other metrics of the cash or product, such as using acquiring sensors to acquire the density, geometry, color interaction of the products/cash to match to those metrics established in a database of the inventive software to authenticate the cash or product. An acquiring sensor may comprise light wave(s) from the user device. The inventive system may further recognize color shifting ink with or without altering the horizon/tilt of the currency. The inventive system may utilize UV light in a user's device or as an add-onto search for magnetic ink, IR inks, and may detect watermark or other sub-detectable features like 3D ribbons, security threads or other security features known in the industry to authenticate currency. In a related embodiment to this currency authentication, such a standalone or stapled-on feature to a user device for currency authentication may alternatively be offered separately as its own application, to be offered on a subscription basis or sold as a software application, optionally with attachment tools for the user device for the sensors described above. In yet other embodiments of the invention, voice commands may be deployed for the inventive system and method utilized in a software application. Similarly, voice recognition, and/or biometric/facial recognition may be used for authenticating the identity of the first and/or second users, along with other security measures such as two-step authentication and others known in the arts. In yet another embodiment of the invention having layers of security, the users may opt to record video and audio of the transaction, phone calls, exchange of the thing(s) of value, of the mapping tracks, and other aspects of the overall agreement. Such audio and video may be stored in a server within the system of the present invention for later confirmation and/or verification of the facts thereof, including within the legal system if disputes arise as to the formation and/or performance of the agreement. In a similar yet additional embodiment of the invention, the system may include a reporting function that can transmit as part of the standard process or as a step-up per request by the user(s), the reporting function having the capability of retaining data and transmitting data surrounding single transactions, a historical review of selected transactions, or other elements of the data relating to the users and transactions to which they were a party. In another aspect of this embodiment, the software application includes a reporting function controlled by the user(s) who may create reports based upon data that is controlled or relevant to the user. In yet another embodiment of the invention, the device(s) of the users or agents of the users may be used as a mobile billboard or security confirmation, whereas a user may hold up his phone so that its screen signals the other user, the community of users in the nearby public area, or even non users of the first user's availability to operate and exchange products, items, money, electronic funds/currencies, credits or services. The phone screen may be set by the user to one of the preset mobile billboard screen profile that is appropriate to be highly visible within the environment of the first user (dark, sunny, rain, etc.) thus clearly signaling availability that is minimally or not disruptive within the environment. Alternatively, this embodiment may include a user's capability to create a signal that is maximally disruptive, or has the capability to stand out from other stimulus within the targeted environment.

The foregoing security and authentication measures discussed in various embodiments may be deployed in real practice as follows. For cash intake persons such as bank tellers, casino changers, or other retail providers who intake cash, the authentication of cash in real time through electronic means will provide the ability to carry out these tasks more securely.

According to some embodiments of the invention, after the confirmation of the exchange takes place with all post/process is met with products, items, money, electronic funds/currencies, credits or services and accepted, the post from the first user is erased from user interface view or map. Historical views may be limited to the transacting users. In other embodiments, other groups or sets of users may request reports on or view as a map to see areas of sales/transactional history. In other embodiments, the first or second user may optionally view the transaction after completion.

In other embodiments of the invention other things of value may have a scope beyond transferring funds as described above. The first user may trade back items of value to include gaming credentials, game tickets, free meals, gift cards, coupons, or other things of value without limitation. Even further, the first user may trade back services in exchange for cash or purchased goods. Other exchanged items of value may comprise services, labor, agreements, employment, or other things of value. In yet another embodiment of items of value, a first user may request recurring or subscribed goods or services. By way of example, a first user may request delivery of a pizza on Fridays at noon for a set price, or request mowing a lawn every Saturday morning for a set cost, so that second users may have the ability to agree to regular tasks on a person-to-person level. In this embodiment, the second user may incur less of a transaction rate than through conventional credit card rates or other financial transfer methods currently in the arts.

In other embodiments of the invention, the thing of value given by the first user to the second user in return for cash or other financial instruments may include terms of payment, so that the full value is not received at the time of the transaction by the first or second user. Interest may be applied to these terms as well. In still other embodiments of the invention, the inventive system may include transferring cash money or other things of value for electronic transfers across different monetary platforms. Thus, while the first user may request cash of a certain currency, the thing of value in return to the second user may be understood to be broad enough to include different currencies, cryptocurrency, precious metals, whose ownership etc. that may be transferred across electronic or digital means. The inventive software application may index in real time, all values of currencies and cryptocurrencies. In this embodiment, the software may auto-calculate a current percentage offered by a cryptocurrency vis a vis a current value of USD at the time of the transaction so that a fair and correct market value of exchange is captured, and may further be configured to store these rates of transfer at the time of the transfer as well as the auto-calculated exchange rate.

In another embodiment, robots, drones, or other machines may be used to deliver or receive the cash money, or be used as proxy stand-ins for the first and/or second users. In a similar embodiment, 3rd parties may deliver the money or items for the first user or the second user. Even further, the inventive software application may serve as a gateway to delivery services for fulfillment of the agreed-upon transaction by the first and second parties.

In other embodiments of the invention, a 3rd party guarantor may be utilized to provide credit for the credit issuer. In this instance, if a first user does not have the financial credentials, or in a scenario where the financial accounts of the first user are temporarily unavailable, the first user may utilize the financial credentials of a 3rd party. The 3rd party may interact directly with the inventive system or may utilize another outside financial services platform to provide said credit, electronic cash transfer, or other transfer of things of value to the second user in lieu of the first user proving said payment. For example and not limitation, a secondary lending company may be affiliated with the software application in such a manner as to provide instant or contemporaneous approval for one or more of the parties who needs to provide things of value in return for cash or other things of value, so that the secondary lending company could then provide payment to the other party in the transaction. The secondary loan institution, or any 3d party assisting with the transfer of financial payments or other things of value may include an online portal for the user(s) to enter in financial information necessary for the financial institution or a group of financial institutions to evaluate, bid, and/or accept the loan to the user(s) to complete the terms of the subject agreement. APR calculators may be utilized to show the cost of distributing or lending amounts of money or other things of value, including by way of example and not limitation, profit amounts for lending parties or financial institutions, terms, length of payment back to the lending party (3 months at 10%, 6 months as 15%). In yet another aspect of the inventive software application, one of the user(s) may originate the loan to another user based upon any number of motivating factors, such as pre-existing relationship, proximity of residency or other factors as agreed upon by the user(s). In yet another embodiment, multi-month payments may be auto-charged in full to the user and paid by the inventive system itself or may be paid by the user.

In other embodiments of the invention, the inventive software application and particularly its postings by the first or second users may be embedded in or stacked along with other applications or agents, such as car sharing applications, online bank interfaces, and social media/communication applications such as snapchat, Facebook, twitter, Instagram, and others known in the arts to be able to facilitate links to other apps, posts, or other means of embedding the software application posts featuring offers by first, second or other adjacent users of the inventive application.

Either in conjunction with the aforementioned social media and other applications, or existing within the inventive software application, it may facilitate reputation building for users within ongoing transactions with other users. By way of example, users may subscribe to and receive notices of posted offers/alerts by first users or scroll by topic through user's channels, or by a specific person, genre, type of keyword or topic or product. In the instance that first users are seeking items of value to offer things of greater value (such as transferred funds), users could “like” or otherwise engage a setting preference for precious metals, cards, guns, gems, any other item category, and receive notice.

In other embodiments of the invention, users may further define a geographic preference or range to view items of interest posted. By way of example and not limitation, a second user may search for a first user who is posting interest in a particular item for sale for cash or within 100 miles of the second user. In another example, a second user may set definable criteria, such as any transaction between $100 and $300 less than 20 miles away. Users may engage settings in setup, in menu/view settings, or use default settings to view postings or alerts by other users. For example, users may draw a perimeter or geofence and label a search string “tickets or cash” in the vicinity of a sporting event. Even further, the users may attach a photo of local landmarks to give other users an orientation of the geofence and or the location of the user.

In other embodiments of the invention, other user interactions within the inventive software application are well-within the scope, such as screen interactions to convey approval/disapproval (swiping a particular direction), commenting upon posts or a user's profile, joining channels of users who have been added to a channel or other group of interest (such as antique cars) either through a positive action or through algorithmic suggestion or a similar passive addition. Users may hold upon other users' names on the user interface to populate their screen with the profile of the user of interest. User inputs may be entered through voice commands or facial recognition. Users may classify other users as friends, family, community, area, state, etc. to create associations and trust or ratings and ability to request shared friend or x number of degrees from you, and send out requests for comments or reputation boosts. Users may view how many degrees away other users are, and create relationship trees of those degrees to correlate friends between you. Users may opt to broadcast a post over the software application, going live or utilizing a push to talk button within the app. Alternatively, the user without an existing network may record a message to broadcast to communicate with one or many a stranger (not in contacts) who is routing or coming to location, giving the user the ability to join a channel and communicate with another live user without existing trusted user or friend status, merely based on proximity or definable area. System may utilize push-to-talk or video chats both built in or via 3^{rd} party for communications between users or prospective users, thus allowing instant communication with another person not in your contacts. Voice and video recording in the software application may be implemented as an option for users for a multitude of advantages, not limited to identification confirmation, transaction modifications, security purposes, and others within the scope of the invention.

In another embodiment regarding the network with which the software application may operate, users may further request close proximity beacons, for example a local Bluetooth range before a GPS signal or response connects first, utilizing authorized phones nearby (friend or family phones) or devices initially. After a period of time or sequence that may include other variables, the software may auto expand its signal search and request by type or geographical area, giving closest users an options to fulfill the requesting users before other users have the same opportunity. For example, a geofenced area of a user needing a quick ingredient for a meal, but no users respond or no agreement is consummated. The inventive application may be optioned to auto-expand (or become smaller, stretched or any other variations of the original geofence) to include a greater (or lesser) range of potential users and prospective contracting parties. In other embodiments, a user's area in the map may by dynamic, following for example the user's travel after the initial posting of the offer.

In another embodiment of the invention, an entity operating within and even outside of the geofence or relevant area around the first user may comprise or have agency over the second user or group of users. The entity may provide a one or more notification buttons that may exist outside of the first user's personal device, such as a notification button in a technology tool, card, proximal machine or other device separate from the user's device, or other fixture/device that is accessible by the first user. The notification button may notify the entity or its agents of a need for products, items, money, electronic funds/currencies, credits or services, and may further include user interface tools or screens to communicate the first user's preferences. The first user may engage the notification button generally, or be presented with options for requesting various amounts of cash money and other selected options. By way of example and not limitation, after the user engages the notification button, an announcement may be disseminated through established communication channels including devices, billboards, or other interfaces. In this embodiment, the entity may provide the wireless signals and credentials to join the network necessary to operate the inventive software application, and thus utilize the data produced therein for a number of advantageous purposes such as location and tracking for targeted advertising. For example, in a casino, the user may be provided with advertising based upon their previous or current location and interest history.

A similar embodiment of the invention may relate to a b2p (also known as “business to person”) system that may be geolocation-based. In this embodiment, users and potential users within a defined area may be subject to an identification system subject of the inventive system, the identification system utilized for target marketing and cash delivery agents utilizing b2p contracts. The concept of b2p may further involve utilizing employees of the business(es) within the defined are subject to an identification system. In this aspect of the embodiment, etp (also known as “employee to person”) or s2p (also known as “site to person”) may be utilized to exchange things of value as described in other embodiments of the present invention that a thing of value may be serviced by a business in the defined area to another user. Finally, the concept of two users utilizing the software application within the defined area, subject to an identification system, may be described as users having no formal or existing relationship, to with s2s (also known as stranger to stranger). In each of these examples, an end user is acquiring a thing of value that may be controlled by a business, a user, or other entity within the defined area and subject to an identification system.

To describe this aspect of this embodiment in a real world example (without limitation to other examples), a seeking user may enter into a defined area, comprising a narrow scope such as a business or a department thereof, or a broad scope such as a mall, shopping center or other collection of businesses. The user may preset so that it only receives specific notifications within pre-defined locations. The geofence location of the defined area may trigger a number of possible digital triggers with the user, most commonly experience through a digital device controlled by the seeking user. The digital triggers may include by way of example and not limitation, an automatic launching of the software application on the user's digital device, a prompt within a mapping software already utilized on the user's digital device that a 3rd party software is available for download and/or in map use. As described elsewhere herein, the software application may be embedded within other social media, mapping and other utility applications already popular and trusted by users. The seeking user may post a request for an order for a thing of value, sold by a business in the defined area or possessed by another user or entity in the defined area, including food, consumer products and services, tickets to events, and other things of value. Thus, the seeking user may acquire a product, service, or other thing of value without leaving his or her automobile, ride, transportation, or without entering the business or indoor location of the product, good or thing of value. The seeking user may avoid long lines, physical interactions indoors, and other environmental factors that the seeking user wishes to avoid for one reason or another. Further, the seeking user may wish to seek things of value before entering the defined area by interacting with a map on the user's digital device to preview options, compare, and optionally select an area of interest, thereby interacting with the described inventive method outside the defined area. The seeking user may have multiple items needed inside a business, or a “to do” list that may be synchronized with the software application so that relevant requests are sent to other users in a locations where such a relevant item or thing of value may be found. Even further, the “to do” list (including embodiments that are powered or supplemented by artificial intelligence) may be processed by the inventive system and method to be matched with providers of products, items, money, electronic funds/currencies, credits or services. The matched providers may further be communicated back to the seeking user in an existing assistant application, mapping software, or other 3rd party application so that the work of fulfilling the “to do” list now has suggested solutions with directions, routing and other helpful assistance for the seeking user. The suggested solutions thus guides the seeking user to matched providers, who also may deliver the products, items, money, electronic funds/currencies, credits or services already subject to the matched provider who is purchasing or providing the products, items, money, electronic funds/currencies, credits or services. The matching provider may be matched for a suggested solution upon proximity, its own “to do” lists, or daily living. Prior to do lists and generally daily living tasks that have been tracked and inputted as existing data of the user may be utilized for suggested solutions to the seeking user, even in scenarios where the seeking user has yet to actively requested the products, items, money, electronic funds/currencies, credits, or services list. In a similar way as described herein, the other users may agree to become a fulfilling user and purchase an item for the seeking user, or otherwise provide a service or thing of value to the seeking user for compensation from seeking user. The compensation may be set by the seeking user in some embodiments, but may be negotiated between the seeking user and fulfilling user in other embodiments. In still other embodiments, the compensation may be set by the inventive software application to calculate a market rate for delivery in the area according to factors such as supply and demand, outside environmental factors, spike usage, the risk involved with any given purchase and other factors that may be combined into an algorithm. Compensation may further include tipping, requirements as to payment form requested by fulfilling user. 3rd party party-users to the agreement between the seeking user and fulfilling user may be added optionally to the transaction so that other users may act as subcontractors for any party to deliver or accept the subject goods, services or other things of value and be furthermore compensated in a similar way as discussed herein within the software application. Compensation may include automatic calculation of taxes, duties, currency changes and other factors additional to a value of goods, services and other things of value listed by the business or offering user controlling the thing that the seeking users wishes to acquire.

In the embodiment of the software application being embedded within another social media application, mapping software, or other application for use, the inventive software application may launch when within a defined area, and then escape or release back to the other social media application, mapping software, etc. after the seeking user leaves the defined area or confirms that the agreement has been fulfilled.

In a similar embodiment, the geofence location of a defined area may notify those within the defined area of a seeking user's needs for goods, services or other things of value. In this embodiment, the seeking user may select a location on the map by interacting with the screen (manual screen interface), by entering a location name or address by typing or voice command or other ways known in the arts to identify a place or business location. The seeking user's need may be reported to all those within the defined area. Those interested in engaging the seeking user may accept the request from the seeking user along with the compensation commensurate with the good, service or thing of value. The defined area may be preset by the user or users, by the administrator of the software, by artificial intelligence based upon a number of factors. As controlled by the admin or AI, the defined area may also expand or contract based upon the availability of things of value sought by the users. Users may opt to see such dynamic defined area availability, in another embodiment of the invention. The embodiment of a dynamic defined area may be utilized as a user travels to different locations, contracting and expanding as needed and/or determined by the software application. This embodiment may see other unexpected benefits. Users may alert one another or a general category of users for noncommercial reasons to build community trust and welfare. For example, if a user notices an undesirable issue that may damage the value of another vehicle, others' property, with pets or livestock outside of their intended care, or other matters that could cause undesired outcomes, then the noticing user may send out a general or specific message so that the undesirable issue may be corrected by the community or the affected user.

In another embodiment of the invention, artificial intelligence may be utilized to supply users to heightened demand. Users of the system may receive alerts to be routed to needed areas. Second users near ATM machines may receive alerts that the need for cash is spiking at a nearby location, thereby notifying the second user(s) to acquire a supply of cash at the ATM machine and then reroute to the location or event where the requests for cash, items of value or services are needed. Data acquired by the software application may be used to further balance the supply and demand, or aid in the fill rate/time when it is too low or high. In times of very high demand spike, second users or those delivering may get resupplied by ad hoc or planned team members for a profit share or set cost, thereby turning the second user into a first user requesting cash, by way of example. The inventive software application may auto-match users based upon history and transactions of need, and may create zones of high demand areas for users to select on a map to travel to for delivering cash, items of value or services. In circumstances in which data informs the inventive software application that ATM machines are not working or out of cash, or other circumstances inhibit the ability to access cash in geographic areas, the above AI actions may create self-healing cash networks for down cards, networks, or when ATM's or any other circumstance which inhibits ability to obtain cash or any other goods or services.

In a second embodiment of the invention, a secondary source of payment may be provided for a first user in the form of a wireless interaction with an ATM machine, or any devices/persons which may have a wireless transaction with anyone or thing with cash available, such as register, ATM, vault, box, register, hardware or agency/person/company/device which may be able to transfer cash with wireless interaction with said inventive process. In this embodiment, the second user may be substituted with an ATM that fits the terms of the first user's request, including added delivery charges that are calculated according to the distance from the fulfilling user and the seeking user who will receive the good, service or thing of value.

The business itself may embed the inventive software application for exchanging products, items, money, electronic funds/currencies, credits or services for other products, items, money, electronic funds/currencies, credits or services within its own store software application. In this embodiment, the business is able to add an additional b2p service to customers by receiving inquiries as to a good/service, showing those currently available, and processing payment as described above and generally to deliver goods/services outside of the business (such as in a parking lot, outside a defined area, etc.). Employees or agents of the business may be available within this inventive method to assist the customer in real or near-real time communication to ensure any special considerations are addressed. Multiple businesses may collaborate to fulfill one or more seeking customers' requests, in sequences of time and need. By way of example and not limitation, an after-dinner milkshake from a separate business may be ordered and delivered to a restaurant where the seeking user is currently located (but does not offer the specific good/service like a milkshake), using the separate businesses Wi-Fi, geolocation capabilities, user's submitted picture, and other factors to fulfill this request. In another example, an elderly person needs a water hose, pulls up to a store parking lot in a numbered parking spot. The elderly person becomes a seeking person on the inventive application for the garden hose, and selects from the group of friends only (rather than strangers or store employees) to deliver the garden hose to the predefined location/meeting area, in this example a numbered parking spot.

Promotions for goods, services and other things of value may be managed in this software application. The seeking user may include coupon, promotion, or other special ordering information in its request. In other embodiments, the seeking user may receive other promotional information from fulfilling users, businesses, or other providers of things of value according to posted needs, prior ordering history or other profiles established by the software application to target the seeking user's anticipated needs, including notifications that are specific to the user once in the defined area. The software application may thus establish mutual commercial relationships with those fulfilling users, businesses or other providers of things of value.

Fulfilling or second users may acquire reputation through software application usage, recommendations by seeking users, successful transactions, by providing in-app support to other users outside of a transaction, and through other tasks that build value and trust in the fulling user. Top users may then be ranked according to sales, trust ranking, usage, recommendations or other attributes generated within the software application and as promoted by other users. Such rankings may be selected by time periods (day, week, month), location, subject area (goods, services, things of value) and other specific categories.

The ATM may authenticate the identity of the first user through the inventive system, and deliver cash through its normal output but without the manual interaction of inserting a credit/debit card, and pressing buttons on the ATM. In this scenario, a parent may provide a sub card for a child, spouse or other user that may have pre-set limits on the amount of transfer as the first user, and otherwise hiding full access and credit numbers from those using the sub card account of the first user. User accounts may also have two factor authentication to use its accounts, or require two factor authentication for any amount over a set limit. The ATM may also report that emergency to law enforcement agencies.

In yet another embodiment, the software application may include an SOS or emergency feature that enables communication immediately with total strangers. Urgent help notice may be alerted to anyone who has app within set range. If a user needs fuel, has an accident, is a victim of a crime (kidnapped, hostage, etc.) the user may notify close proximate people with definable text/pics/videos along with an option to alert law enforcement. When close to phone or come into said area the user may receive a response or in case looking from someone even down to Bluetooth range. The user may be blocked from SOS alerting feature for any misuse. The software application, in this embodiment, may immediately build a geofence area around your location for notice awareness. The failure of all programs is they gain no traction by themselves so SOS may be embedded into and part of all major used apps the subject software application to empower mass users by location.

Users may create avatars that may be ranked by various measures. For example, upon a map that displays all avatars, highly-reputable (5/5 stars and/or large number of transactions) may be embellished with additive ornamentation, size, stars, or other displayed methods for notifying seeking users of the status of the user's avatar.

While the present invention has been described in conjunction with the specific embodiments set forth above, many alternatives, modifications and other variations thereof will be apparent to those of ordinary skill in the art. All such alternatives, modifications and variations are intended to fall within the spirit and scope of the present invention.

What is claimed is:

1. A method for a user to digitally trade things of value for products, items, money, electronic currencies, credits or services delivered in person, the method comprising the steps of:
Creating a profile on a software application for a seeking user, the profile including a transfer protocol for transferring an asset owned by the seeking user to another user;
Requesting a good, service or thing of value from a group of fulfilling users of a software application deployed upon a personal device;
Selecting a fulfilling user from the group of fulfilling users that agree to fulfill a request of the seeking user;
Receiving by a seeking user of the good, service or other thing of value from the fulfilling user; and
Transferring an asset to the fulfilling user using the transfer protocol.

2. The method in claim 1 further comprising:
Enabling at least one personal device of the seeking user and the fulfilling user to communicate with the system;
Establishing a geofence about a selected location;

3. The method of claim 2 further comprising:
Activating the notifications for the seeking user and group of fulfilling users when occupying a location within the geofence.

4. The method of claim 2, the step of creating a geofence about a selected location further comprising:
Enabling the seeking user to select the scope of the geofence for the group of fulfilling users to receive notifications of an offer to an asset for a good, service or other thing of value.

5. The method of claim 1 further comprising:
Inputting a task list relevant to the seeking user into to the system;
Processing the task list to sort the task list into identifiable goods or services that may be fulfilled by the step of requesting a good, service, or thing of value from a group of fulfilling users of a software application deployed upon a personal device;

6. The method of claim 5 further comprising the step of using the profile of the seeking user to create parameters for attributes selected from the group of: defined area, range of values of identifiable goods or services, preferences for fulfilling users.

7. The method of claim 5 further comprising the step of using historical information of past usage by the seeking user to create parameters for attributes selected from the group of: defined area, range of values of identifiable goods or services, preferences for fulfilling users.

8. The method of claim 1 further comprising the step of authenticating the identity of a seeking user and of fulfilling user using at least one security protocol.

9. The method of claim 1 further comprising the step of authenticating the value of the good, service or thing of value.

10. The method of claim 1 further comprising the step of validating the asset from the step of transferring an asset to the fulfilling user using the transfer protocol.

11. The method of claim 2, whereby selected location is the seeking user, so that the geofence dynamically changes about the location of the seeking user.

12. The method of claim 2, whereby the step of establishing a geofence about a selected location may further comprising increasing the range of the geofence after a period of time elapses without a fulfilling user agreeing to fulfill the request.

13. The method of claim 10, whereby the asset is cash currency and the step of validating the asset comprises a measure on the personal device of the seeking user for authenticating the cash currency.

14. The method of claim 9, whereby the thing of value is cash currency and the step of validating the cash currency comprises a measure on the personal device of the seeking user for authenticating the cash currency.

15. The method of claim 1 further comprising the step of establishing a market rate of the thing of value for evaluation by the seeking user or the group of fulfilling users.

16. The method of claim 15; further comprising the step of establishing a market rate of the asset for evaluation by the seeking user or the group of fulfilling users.

17. The method of claim 16, whereby the market rate of the asset and the thing of value are compared and a exchange rate is established for evaluation by the seeking user or the group of fulfilling users.

18. The method of claim 1 further comprising the step of establishing an emergency security engagement within the software application on the personal device of the seeking user or the fulfilling user to contact emergency services.

19. The method of claim 1, whereby a server stores the software application service, the data created by the user of the software application, and data created by the interactions by all seeking and fulling users of the software application.

20. The method of claim 1 further comprising providing in the software application a push to talk engagement for the seeking user and fulfilling user to communicate without disclosing identifying data of the personal device.
